(19) United States
(12) Patent Application Publication
(10) Pub. No.: US 2007/0275304 A1
(43) Pub. Date: Nov. 29, 2007

(54) Method and Plasmatron for the Production of a Modified Material and Corresponding Modified Material

(76) Inventors: Joerg Friedrich, Erkner (DE); Gerhard Kuhn, Berlin (DE); Reinhard Mach, Berlin (DE); Heinz-Eberhard Maneck, Wildau (DE); Walter Schutz, Weidenberg (DE); Ludwig Jorissen, Neu-Ulm (DE); Ulrich Storr, Ulm (DE); Margret Wohlfahrt-Mehrens, Illertissen (DE)

Correspondence Address: KRIEGSMAN & KRIEGSMAN, 30 TURNPIKE ROAD, SUITE 9, SOUTHBOROUGH, MA, 01772, US

(21) Appl. No.: 10/576,353

(22) PCT Filed: Oct. 14, 2004
(86) PCT No.: PCT/DE04/02286

§ 371 Date: Feb. 5, 2007

(30) Foreign Application Priority Data
Oct. 16, 2003 (DE) 103 48 193.1
Jan. 15, 2004 (DE) 10 2004 002 236.4

(51) Int. Cl. H01M 4/58; H05B 6/02; H05B 7/00; C01B 31/00

(52) U.S. Cl. 429/231.8; 264/431; 373/18; 423/414

(57) ABSTRACT

Among other things, a method for the production of a modified material, for example, a carbon material, is described, having the following steps: Generation of a high-frequency field in a chamber (2) of a plasmatron (1); introduction of a plasma gas into chamber (2); generation of a plasma with the plasma gas by the high-frequency field; and introduction of initial material into the plasma. In addition a plasmatron (1) is described for the production of a modified material (M), having: a chamber (2), at least one high-frequency inductor (3) disposed in at least one region of chamber (2), a gas supply line (10, 11) for introducing a plasma gas into the region of a high-frequency field generated by high-frequency inductor (3), and a material supply line (4) for blowing in initial material with a transport gas into the plasma generated by high-frequency inductor (3) with the plasma gas. Finally, it also describes a modified carbon material which is correspondingly produced.

The present invention first of all relates to a method for the production of a modified material. In addition, the invention relates to a plasmatron for the production of a modified material as well as a corresponding material. For example, modified carbon materials or other oxidizable materials may be involved. The invention will be described in different ways below based on modified carbon material for better illustration, wherein the invention is not limited, of course, to the described examples.

At the beginning of the '90s, lithium-ion rechargeable batteries were introduced into commerce. In comparison to the previously known alkali-manganese batteries or nickel-cadmium rechargeable batteries, these lithium-ion rechargeable batteries have a higher charge density and better energy release behavior. The behavior is very different in each case, depending on temperature, discharge current and discharge voltage. Lithium-ion rechargeable batteries, however, are usually much lighter, whereupon a higher energy density results. The anode is produced from carbon, a “light” material.

In this type of rechargeable battery, LiCoO₂ is used predominantly as the cathode material. For example, the anode is comprised of graphite, in which lithium ions that are migrating from the cathode during the charging process of the rechargeable battery can be reversibly charged. However, there are also Li-ion rechargeable batteries, which are not comprised of graphite, but of other carbon materials, such as, for example, hard carbon, a mixture of different carbon materials, or similar materials.

For the most part, highly pure organic solvents, such as, for example, ethylene carbonate or propylene carbonate, to which are added lithium-containing conducting salts, such as LiClO₄, for example, are used as the electrolyte in this type of rechargeable battery. At the present time LiPF₆ is used predominantly; a standard electrolyte, for example, is comprised of a mixture of ethylene and dimethyl carbonate (1:1) containing LiPF₆ (1 molar).

Lithium-ion rechargeable batteries are predominantly utilized in portable devices, for example, video cameras, wireless devices, laptop computers, digital cameras and similar devices, wherein a high energy density is also necessary in addition to a minimum space requirement. Also, lithium-ion rechargeable batteries have been developed for application in automobiles, in order to comply with the greatly increased current needs of modern vehicles. Several manufacturers are also developing new batteries/rechargeable batteries, for example, for the future 40 V on-board network of vehicles.

The trend in device development, among other things, leads to miniaturization and to new and different, small, portable devices, which all require lightweight and rapidly rechargeable current sources, e.g., notebooks, PDAs, cell phones and the like. Also, the combination of camera and cell phone as well as new transmission standards, such as UMTS, can result in higher power consumption.

Many battery manufacturers are thus developing better electrode materials, which will have both a higher cycle stability as well as also a smaller irreversible capacity.

In Li-ion rechargeable batteries, a small part of the lithium is irreversibly bound to the surface of the anode during the first few charging cycles (this process is concluded for the most part after the first cycle). Therefore, in complex chemical reactions, a mixture of lithium oxide and high-polymer decomposition products of the electrolyte, the so-called “Solid Electrolyte Interface” (SEI) is formed. Impurities and surface groups containing heteroatoms of the carbon material also participate therein. This SEI is absolutely necessary for the function of lithium-ion rechargeable batteries, since it allows only the lithium ions to pass through it and not the electrolyte molecules. The aim is to produce a firmly adhering, flexible layer that is as thin as possible.

The layer should thus be as thin as possible, since an irreversible reaction is involved, that is, the lithium is supplied by the cathode and is now no longer available for further cycles.

“Firmly adhering and flexible” is thus desired, since during the lithium intercalation, the volume of material clearly increases. The SEI must participate in this process without scaling or becoming porous, since, if it did, solvent molecules (electrolyte) would become embedded between the graphite layers and this would lead to a splitting of the layers (“exfoliation”) and thus to a clear decrease in capacity and cycle stability.

Irreversibly bound lithium ions no longer participate in the further charging and discharging cycles. The loss of capacity of the rechargeable battery that arises in this way is compensated for by an excess of cathode material in the production of the rechargeable battery, which, however, leads to an increase in the weight of the rechargeable battery and thus to a reduced specific energy density of the rechargeable cell relative to weight or volume.

Pure graphite has a perfect layer structure and lithium ions can be intercalated between the graphite layers. In this case, each lithium ion is surrounded by six carbon atoms. An intermediate layer is always completely filled with Li ions, but the directly adjacent layer as the next layer is not filled at first, but rather a layer that is further removed is filled. The adjacent layers are only filled toward the end of the process. If lithium ions are intercalated between all graphite layers, the compound LiC₆ is formed; with incomplete intercalation, of course, other stoichiometric ratios may also arise, for example, LiC₈, LiC₁₂ and similar compounds.

The compound LiC₆ corresponds to a capacity of 372 mAh/g, which is the maximum possible for graphitic carbons. Non-graphitic carbons can reach higher storage values, in part due to other intercalation mechanisms.

Based on the above-described effects of irreversible SEI film formation, in contrast to this theoretical value, graphite electrodes that can be used practically have a specific capacity of only approximately 300-320 mAh/g, so that a reduction in capacity of 50-70 mAh/g can be attributed to the formation of the SEI film.

In several of the commercially obtainable Li-ion rechargeable batteries, MCMBs (meso carbon microbeads) are used. These beads are processed with a suitable binder (for example PVDF) and conductive carbon black into the electrode mass. Other manufacturers use hard carbon or mixtures of different carbon materials. MCMBs are comprised of carbon particles, which in turn are agglomerated into larger spherical particles (1-80 μm). Such cells provided with MCMB anodes reach a specific capacity in the range of approximately 350 mAh/g. The disadvantage of MCMBs is their high price, for which reason, materials that are as equivalent as possible but of lower price are sought.

MCMBs are produced by a very expensive multi-step process, which is the reason for their high cost. Another disadvantage added to this is the fact that the MCMB material cannot be produced in Europe due to environmental injunctions.

General goals for further improvements to lithium-ion rechargeable batteries, in addition to reducing costs, are to attain an increase in energy density, to decrease the irreversible Li losses, to obtain a high cycle stability as well as to make possible a safer operation of the cells. In order to be able to obtain a high energy density in the cells, the consumption of Li for the formation of the SEI film must be reduced to a minimum. Although the SEI is absolutely necessary for function, it should be thin and adhere firmly (see above). The formation of the SEI depends on many factors, e.g., impurities, type of electrolyte, additives to the electrolyte (for example, vinyl carbonate), surface state of the carbon material (surface groups, roughness, accessibility of the “edge sites”, amorphous carbon), BET surface and similar factors.

It is thus absolutely necessary to influence the shape and the surface groups of the carbon particles in such a way that a small BET surface and a rounded shape result, whereby both a small irreversible capacity as well as a high number of cycles can be achieved.

A previously known approach to improving anode material for Li-ion batteries consists of modifying the graphite surface by generating functional groups by means of a gas-phase or liquid-phase oxidation, which is performed subsequent to a high-temperature treatment. An oxidation increases the proportion of surface groups containing oxygen and in this way reinforces the formation of the SEI. As a result of this treatment, closed structures are formed on the graphite edges of particles (the closed structures are formed during the high-temperature treatment (HTT), approx. 2500° C.), which are similar to the “platelet” structure of GNFs (graphite nanofibers) or the tips of nanotubes and are designated “nanoterminated surface structures” (NTSS) (Moriguchi et al., J. Appl. Phys. 88 (2000), page 6369 ff, Physica B 323 (2002), page 127 ff).

Another approach to surface modification of carbon materials consists of a high-temperature treatment in an argon atmosphere, whereupon a type of cleaning of the surface will be achieved, and of the subequent reaction of the graphite surface with reactive molecules such as NH₃, O₂, CO₂, SO₂, H₂S, C₂H₂, and similar molecules. In addition to the chemical modification of the surface, the reactive gases may also contribute to the modification of surface morphology (Buqa, et al., J. Power Sources 97-98 (2001), page 122 ff).

Yet another approach known in the prior art is the wet-chemical treatment of carbon materials with strong acids or bases. Thus, for example, by treatment with concentrated nitric acid, the graphite surface is extensively modified in such a way that a dense layer of oxygen-containing surface structures is produced, which leads to the increase of the reversible capacity from 251 mAh/g to 335 mAh/g in the tested case as well as to a very high cycle stability (Wu et al., J. Power Sources 111 (2002), page 329 ff). In wet-chemical oxidation, however, many oxygen-containing groups are formed on the carbon surface and these reinforce the formation of lithium oxide during the SEI formation and thus lead to the formation of a thick SEI layer and thus to a high irreversible capacity.

The object of the invention is thus to provide a modified material, in particular a carbon material, which is inexpensive and has improved properties.

This object is achieved by the method according to the independent patent claim 1, a plasmatron according to the independent patent claim 13, a carbon material according to the independent patent claims 20 and 21, as well as by use of a carbon material according to the independent patent claims 25 and 28. Additional advantageous configurations, aspects and details of the present invention result from the dependent claims, the description and the appended drawings. Features and details, which are described in connection with the method according to the invention thus also apply, of course, to the plasmatron according to the invention, to the carbon material according to the invention and to the use according to the invention as well as vice versa.

The invention is based on the principle of conducting a surface modification of a material by treatment with a thermal plasma in the case of a specific oxygen partial pressure. This material may involve, for example, but not exclusively, modified carbon materials and other oxidizable materials.

It is also conceivable to coat metals or other materials with a thin oxide layer, in order to modify their magnetic, optical or adhesion properties.

Correspondingly, the invention according to the first aspect is directed to a method for the production of a modified material, which has the following steps:
Generation of a high-frequency field in a chamber of a plasmatron;
Introduction of a plasma gas into the chamber;
Generation of a plasma with the plasma gas by the high-frequency field; and
Introduction of initial material into the plasma.

Subsequently, the treated material is removed.

It is understood that the different steps presented here are not to be viewed as a time sequence, but will render only the logical course of the method. The method according to the invention involves a method that is accessible not only to a batch operation, but also to a continuous operation, as long as the initial material is continuously introduced and the modified material is continuously removed. Thus, all steps of the method according to the invention take place simultaneously. The different steps are dependent on one another, however, since a plasma can be generated only with the existing high-frequency field and introduced plasma gas, and the material can be modified only with the existing plasma.

The invention is not limited to specific types of plasma. The plasma can be generated from all possible gases; reducing gases are also possible. Oxygen partial pressure, however, is absolutely necessary for the spheroidizing and for the generation of functional groups containing oxygen, so that the plasma preferably contains oxygen. When other gases are used, other surface groups can be generated, such as, for example, —C—H, or —C—NHₓ terminated surfaces.

The method according to the invention is suitable for modifying the most varied materials. Preferably, carbon materials can be modified with the method. Of course, all materials are generally suitable, if they react (oxidize) with oxygen and if their oxidation products are volatile in the plasma. In the case of carbon, this is CO₂. It is also conceivable, however, to apply this method to materials whose oxidation products are not volatile and then remained adhered to the surface and form an oxide layer, for example, in the case of silicon, titanium, aluminum and similar elements. This would not absolutely then lead to spherical particles, however.

In particular, the method according to the invention is suitable for the production of modified carbon material, which has graphitic and/or non-graphitic carbon components and also, optionally, hydrocarbon components.

The subject of the method is particularly the modification of carbon material with the following objectives:
Spheroidizing of irregularly shaped particles. Materials that can melt in the plasma beam form spherical, globular particles (metals, oxides, and so forth) due to the surface tension.
Materials that do not melt, such as carbon, for example, but form volatile oxidation products (CO, CO₂), should also be able to be spheroidized. The edges of the particles will preferably be oxidized, and, as a result, one obtains spheroidized (rounded) particles. This is done in thermal plasma by using a plasma with a specific oxygen partial pressure. The oxygen partial pressure is essential in the case of carbon.
O-containing functional groups (—OH, —COOH, —CHO), which influence the formation of the SEI layer, with the use of these modified C materials as the anode material in Li-ion rechargeable batteries, are simultaneously generated on the surface.
The pore structure of the C material is simultaneously changed, whereby mesopores and micropores are also generated.

In general, the carbon material to be modified may preferably involve carbon powder of the most varied granulation. The method is not limited to nanomaterials and is also not limited only to graphite. Rather, all carbon materials (hard and soft carbons, graphitic and non-graphitic carbons, as well as carbon nanofibers and nanotubes) can be modified according to this method, and in fact in the sense of generating surface groups and producing modified pore structure. However, spheroidizing in the sense of burning off the edges is only applicable to oxidizable materials and to the formation of volatile reaction products, as well as also to the diverse other materials such as metals, silicon and so forth.

The carbon material used can originate from different sources, such as, for example, natural coke, natural graphite, graphite, hard carbons, soft carbons, graphitizable and non-graphitizable carbons, anthracite or the like.

A thermal treatment of the initial materials is conducted by the method according to the invention. Here, spherical particles are obtained by oxidation, preferably at the edges of the material—for example, of the graphite particles.

In the thermal treatment, in the presence of oxygen, for example, non-graphitic carbon materials may also be oxidized in preference to graphitic carbon materials. This means that the proportion of graphite will be increased (graphite, particularly natural graphite always contains a certain proportion of non-graphitic carbon materials). A product of higher value will be obtained with a reduction of the proportion of non-graphitic carbon.

In the thermal treatment in plasma, however, specific non-graphitic carbons are also graphitized, so that the graphite proportion is also increased in this way. In this way, a product with improved purity can be obtained.

Preferably, the initial material, for example, carbon material, is introduced by blowing particles of initial material into the chamber with a transport gas. Argon is preferably used as the transport gas, but any other gases, even reactive gases, may also be used.

Instead of small particles, it is also possible to use larger grains or even pellets, as long as a surface modification will be conducted on them. It is also possible to dispense with the transport gas and to transport the initial material, for example, carbon material, in another suitable manner into the region of the plasma.

The grain size distribution of the material is really random, so that the method also functions with smaller particles in the submicron to nanorange. Preferably, the grain size distribution lies between 5 and 80 μm, but it also can be smaller or larger, as long as this is necessary or advantageous for a specific application. Spheroidized particles in the nanometer range are interesting, for example, for optoelectronic applications.

The method may be conducted at any desired pressure. The method can be characterized, however, by the fact that it can be conducted completely at normal pressure or almost at normal pressure. This has the advantage that one can operate with an open system, which permits a continuous operation and the products can be removed without interruption of the method. In addition, different gases may be introduced with no problem.

The possibility of conducting the method at normal pressure is important, since the oxygen partial pressure can be reduced by mixing in inert gas or increased by mixing in oxygen.

In addition, it is not necessary to generate a vacuum or generate pressure (which is associated with very high capital costs), which is of interest from an economic viewpoint.

Basically, the material can be introduced at different sites of the plasmatron, each time depending on reaction conditions. This means that the introduction is not limited to specific sites. For example, the initial material, e.g., the carbon material, can be introduced into the chamber directly at the onset of the high-frequency field or of the plasma, respectively. This can be achieved, for example, by introducing a supply pipe up to the region of the plasms, directly in front of it or even in it, and delivering the material particles, for example, the carbon particles or other suitable carbon material, at an open end of the supply pipe. Since the method according to the invention preferably involves a continuously running method and thus not only the input of material but also its output must be taken into consideration, and the desired effect on material particles, for example, is also determined by the residence time of the material in the plasma, the material is preferably guided through the plasma via an inlet pressure of the transport gas and, after a defined passage time in the plasma, leaves on the side of the plasma that essentially lies opposite the inlet side of the plasma.

Here, the inlet side is to be understood as the end face of the plasma (i.e., a face on the other side of which the plasma remains below a specific concentration), on which face the initial material, for example, carbon material, is supplied to the plasma, thus is introduced into it. The initial material in general passes through the plasma on a path defined by different variables, such as the properties of the initial material (including density, diameter, morphology), inlet conditions and/or plasma parameters and exits again from the plasma on a side that lies substantially opposite. Because of the conditions named in the previous sentence, the residence time and thus the duration of the modification treatment of the material are adjusted.

In another variant, the material may also be supplied to the plasma underneath an inductor of the plasmatron. This can be performed, for example, radially or tangentially from the outside, perpendicular to the plasma axis. The initial material here also generally passes through the plasma on a path defined by different variables, such as the properties of the initial material (including density, diameter, morphology), inlet conditions and/or plasma parameters and again exits from the plasma on a side lying essentially perpendicular to the axis of the direction of introduction. The residence time is also determined here by means of all other process parameters.

Of course, material may also be introduced several times or in several sites, for example, in order to produce different layers (for composite materials) or in order to complete a reaction.

The method according to the invention can additionally be characterized in that it has the further step of separating the modified material, for example, carbon material, in the chamber by means of a mechanical filter, or a cyclone separator, or another known separating method, or even by continuously operating filter systems (separators). A textile or metal filter with a pore size (mesh width) suitable for the synthesis product is used as a mechanical filter. It can be taken off in order to remove the product from the synthesis apparatus.

In addition to the residence time of the material in the plasma, the presence of oxygen is also decisive for the result of the modification treatment. Thus, it is preferred that the plasma gas has a defined oxygen partial pressure, particularly from 10 to 10,000 Pa. In particular, a partial pressure of approximately 2,000 Pa is preferred.

The effects of spheroidizing, selective oxidation and graphitization preferably run in parallel and cannot be separated from one another.

The oxygen content in the plasma gas preferably amounts to 0.01 to 10 vol. %, in order to be able to generate the desired modifications of the material; and in particularly preferred embodiments it amounts to 2 vol. %.

The plasma gas may comprise the most varied species of gas and gas compositions. In addition to oxygen, the plasma gas preferably contains as another gas component a gas that is as inert as possible, for example, an inert gas such as helium or neon. More particularly, argon is preferred as the inert gas that may be used, since it is required for initializing the plasma and, in addition, it is inexpensive.

The reaction may additionally be influenced by means of a reaction gas and/or a quenching gas, which is introduced into the chamber. The reaction gas may involve oxygen, for example. In this case, the reaction gas, oxygen, reacts with the material particles, for example, the carbon particles, in the sense of a chemical reaction (oxidation of carbon to CO and CO₂), whereby, in addition to the stripping of material (spheroidizing), a modification ensues (generation of functional groups, generation of pores, change of morphology). The quenching gas serves for the rapid cooling of the gases, which leave the plasmatron. Thus, the temperature of the particles is rapidly decreased, and one can freeze specific states of the particles, which would change with slow cooling (freezing of high-temperature phases, quenching rate up to 10⁸ K/s).

By means of these additional gases, which are supplied to the chamber as needed behind the actual plasma region, lateral to the flow of graphite material, it can also be achieved that the particle surface is modified in a suitable manner (nanoporosity).

The high-frequency field applied to the chamber for generating the plasma in a specific pre-given region preferably has a frequency in the range of 1-30 MHz, for example, of 4 MHz.

The invention is additionally directed to a system for producing such a modified material, for example, a carbon material. Everything that was stated above for the method according to the invention is logically valid for the system, and vice versa, so that reference is made interchangeably.

The invention is thus directed to a plasmatron for the production of a modified material (for example, modified carbon materials and other oxidizable materials), which has:

A chamber, a high-frequency inductor disposed in at least one region of the chamber, a gas supply line for introducing a plasma gas into the region of a high-frequency field generated by the high-frequency inductor, and a material supply line for blowing in carbon material with a transport gas into the plasma generated by the high-frequency inductor with the plasma gas. The chamber can be a chamber that is common for plasmatrons, for example, made of glass, ceramic or quartz material. Also, the high-frequency inductor may be a common inductor, for example, a three-turn inductor, for a correspondingly dimensioned chamber.

The supply lines are comprised of materials common for plasmatrons in the arrangement specific to the invention for conducting the method according to the invention described above, for example.

It is particularly preferred that the material supply line for the initial material, for example, the carbon material, reaches up to the edge of the plasma generated by the high-frequency inductor. This is accomplished by introducing the material completely into the plasma and not flushing parts thereof to the walls of the plasmatron. The material supply line is preferably joined with a powder transport device for producing a graphite material/gas mixture which is propelled with a transport gas. In the sense of the present invention, a powder transport device is a device which mixes the powder homogeneously with a current of carrier gas and it permits transporting this mixture continuously at a constant volumetric flow rate. The high-frequency inductor is preferably joined to a power generator for the generation of high-frequency current, which can bring the energy for the generation of a plasma into the chamber. The high-frequency generator may have, for example, a frequency in the band described in the method according to the invention, in particular at 4 MHz.

In a preferred embodiment, the plasmatron according to the invention contains, in addition, a gas supply line for introducing a reaction gas and/or a quenching gas, which is disposed behind the inductor away from the inlet side of the plasma. The task and function of these gases has already been described further above.

The plasmatron according to the invention preferably has, in addition, a mechanical filter for separating the modified material.

Further, the invention is directed to a carbon material. This carbon material is a carbon material provided by the action of plasma and oxygen with modified edges or a carbon material that can be produced according to the method of the invention or with the plasmatron according to the invention.

The carbon material preferably has modified edges, which, in comparison to unmodified edges, for example, of an initial graphite material, which will be subjected to the method according to the invention, have a rounded shape. In the case of carbon materials, for the most part, one cannot speak directly of an “edge”. The oxidation of the surface always occurs first at the so-called “edge sites” (ends of the graphite layers). Groups containing oxygen, e.g., —COOH, which then cleave CO₂ under the reaction conditions, are formed there. Thus, the material is burned of at these sites. Now, if a projecting edge is found at such a site, the oxidation of both sides will result and the material will be rounded at this site. The BET surface is reduced and the “edge sites” are decontaminated (for example, groups containing oxygen or amorphous carbon are removed), whereupon the lithium intercalation is facilitated.

Preferably, the carbon material according to the invention has a reduced irreversible absorbing capacity for alkali and/or alkaline-earth ions in comparison to the untreated initial carbon material, for example, for lithium ions used in batteries. This means that the formation of SEI films is reduced in the initial operation of an anode of a battery which is provided with a corresponding carbon material according to the invention in comparison to anodes of the prior art constructed with MCMBs.

Preferably, the carbon material according to the invention has a BET surface of ≦5 m²/g. “BET” is the abbreviation for “Brunauer-Emmett-Teller”, after the inventors of this method for determining the surface. This property is required, in particular, for electrode material for Li-ion rechargeable batteries.

Carbon material may involve, for example, a carbon material which has graphitic and non-graphitic carbon components and, also optionally, hydrocarbon components. Advantageously, but not exclusively, it may involve a graphite powder.

Finally, the invention also relates to use of a carbon material according to the invention as an electrode material for a lithium-ion rechargeable battery, wherein the electrode material is preferably an anode material.

The use preferably includes a method step such that the carbon material is shaped into an anode.

The invention also relates to use of a carbon material according to the invention as an additive for mixtures. The use can thus result such that an initial material is mixed in with the carbon material in order to form a composite material. For example, metal/carbon mixtures, carbon/polymer mixtures and other mixtures may be considered as targeted composite materials.

The method and plasmatron according to the invention lead to the production of a carbon material with improved properties for the intercalation of metals, particularly lithium. In particular, there results an improvement of the surface properties and thus an indirect improvement of the lithium intercalation. The BET surface is smaller and contaminations are cleaned from the carbon surface. This leads to the thinning of the SEI layer and thus to the reduction of the irreversible capacity. Also, the “edge” sites are now more accessible to the lithium intercalation.

This method particularly involves a continuous one-pot method for the production of high-quality, modified carbon materials (graphitic and non-graphitic), which can be used for the production of battery or rechargeable-battery electrodes. It provides carbon materials with modified surfaces with respect to the surface groups, the nanoporosity and the BET surface. Also, the bulk properties of graphite materials, particularly of graphite or natural graphite, but also of natural coals make possible their use as an electrode material for lithium-ion rechargeable batteries.

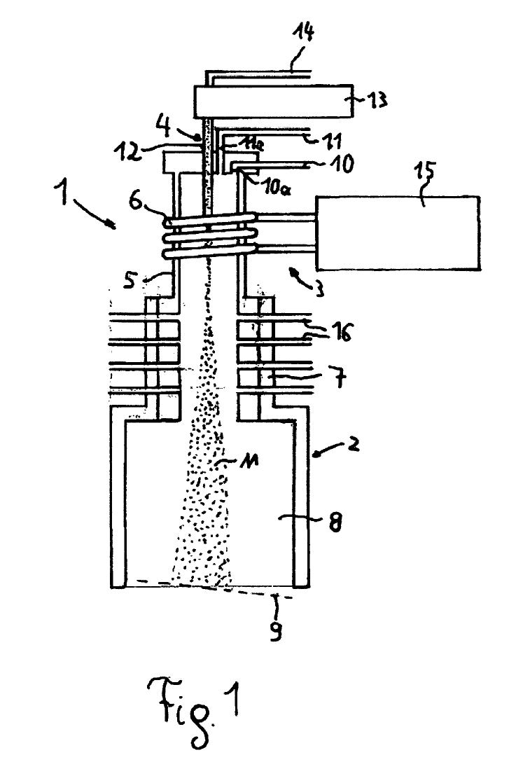

In the following, the invention will be described on the basis of a concrete example of embodiment, wherein reference is made to FIG. 1 in the appended drawing, in which a plasmatron according to the invention is shown.

The plasmatron 1 according to the invention, in the preferred embodiment which is presented here, comprises a multi-member, but one-pot chamber 2, for example, a quartz tube, a high-frequency inductor 3 and a supply mechanism 4 for supplying the carbon material. Chamber 2 has three different sections of different diameter: a first section 5, around which a three-turn inductor 6 is coiled in this concrete case, a modulation region 7 and a collection region 8 with a filter 9 introduced at the end of it. The necessary plasma gases are blown into the chamber via at least one supply line 10, 11 with end regions 10A, 11A reaching into the chamber 2, and subsequently enter into the region of the high-frequency field formed by inductor 6. The carbon material M is blown into chamber 2 via a material supply line 12, which is guided directly up to the windings of the inductor (viewed laterally). A powder transport device 13, which is provided with a transport gas, for example, argon, via a supply line 14, serves for this purpose. The inductor coils 6 are supplied with energy via a high-frequency generator 15, which is designed such that the high-frequency field generated by it by means of the inductor coils can transform the plasma gases into a plasma. On the side of inductor coils 6 which face away from the supply lines lies the modulation region 7, in which supply lines 16 may optionally be provided, which extend laterally into the chamber and serve for the introduction of reaction gas and/or quenching gas.

In the thermal RF induction plasma that has been generated by the inductor with, for example, an Ar/O₂ mixture as the plasma gas, graphite powder, for example—but not exclusively—with a grain size distribution of 50-80 μm, can now be subjected to a treatment at normal pressure in the one-stage and one-pot method. The plasmatron 1 which is used comprises, for example, an air-cooled quartz tube with an inner diameter of 50 mm, in which the power, for example, from a 50 kW generator 15 is excited via the three-turn inductor 6. The graphite powder or another carbon powder is blown into the “head” of the plasma via the material supply line 12 (probe) with an outer diameter of 6 mm and an aperture diameter of 2.2 mm. The tip of the probe is thus preferably positioned at the level of the uppermost inductor winding. In the case of the named dimensions for an exemplary plasmatron, the total gas quantity preferably amounts to 45 standard liters/min in the case of an Ar content of 98 volumetric percent and an O₂ content of 2 vol. %. The generator power can typically amount to 2.5, 5 or even up to 40 kW. The carbon powder, for example, graphite powder, can be supplied to the plasma at 35 g/h in the case of the dimensions and values indicated above. As the last step of the method, the treated powder is separated from the flow of gas with a mechanical filter 9 at the end of chamber 2 which is opposite the supply line.

1. A method for the production of a modified material, having the following steps:
Generation of a high-frequency field in a chamber of a plasmatron;
Introduction of a plasma gas into chamber;
Generation of a plasma with the plasma gas by the high-frequency field; and
Introduction of initial material into the plasma.

2. The method according to claim 1 for the production of a modified carbon material, in particular a carbon material, which has graphitic and/or non-graphitic carbon components and also, optionally, hydrocarbon components.

3. The method according to claim 1, further characterized in that the initial material is introduced by blowing in material particles along with a transport gas into chamber.

4. The method according to claim 3, further characterized in that the initial material is conducted through the plasma by means of an inlet pressure of the transport gas and, after a defined residence time in the plasma, leaves the plasma on the side essentially lying opposite the inlet side of the plasma.

5. The method according to claim 1, further characterized in that this method is conducted at normal pressure or approximately at normal pressure.

6. The method according to claim 1, further characterized in that the initial material is supplied to the plasma underneath an inductor of the plasmatron.

7. The method according to claim 1, further characterized in that it has the additional step of separating the modified material in chamber by means of a mechanical filter.

8. The method according to claim 1, further characterized in that the plasma gas has a defined oxygen partial pressure, in particular from 10 to 10,000 Pa.

9. The method according to claim 1, further characterized in that the oxygen content amounts to 0.01 to 10 vol. %.

10. The method according to claim 1, further characterized in that the plasma gas contains an inert gas.

11. The method according to claim 1, further characterized in that, in addition, a reaction gas and/or a quenching gas is introduced into the chamber.

12. The method according to one of claim 1, further characterized in that the high-frequency field has a frequency in a range from 1 to 30 MHz.

13. A plasmatron for the production of a modified material, having:
a chamber, at least one high-frequency inductor disposed in at least one region of chamber, a gas supply line for introducing a plasma gas into the region of a high-frequency field generated by high-frequency inductor, and a material supply line for blowing in initial material with a transport gas into the plasma generated by high-frequency inductor with the plasma gas.

14. The plasmatron according to claim 13, further characterized in that the plasmatron has means for conducting a method for the production of a modified material having the following steps:
Generation of a high-frequency field in a chamber of a plasmatron;
Introduction of a plasma gas into chamber;
Generation of a plasma with the plasma gas by the high-frequency field; and
Introduction of initial material into the plasma.

15. The plasmatron according to claim 13, further characterized in that the material supply line reaches up to the edge of the plasma generated by high-frequency inductor.

16. The plasmatron according to claim 13, further characterized in that the material supply line is joined with a powder transport device for generation of an initial material/gas mixture.

17. The plasmatron according to claim 13, further characterized in that the high-frequency inductor is joined with a power generator for generating high-frequency current.

18. The plasmatron according to claim 13, further characterized in that it has a gas supply line for introducing a reaction gas and/or a quenching gas, which is disposed behind the inductor away from the inlet side of the plasma.

19. The plasmatron according to claim 13, further characterized in that, in addition, it has a mechanical filter for separating the modified initial material.

20. A carbon material with edges modified by action of plasma and oxygen.

21. A carbon material, which can be produced with the method according to claim 1 or with a plasmatron for the production of a modified material, having: a chamber, at least one high-frequency inductor disposed in at least one region of chamber, a gas supply line for introducing a plasma gas into the region of a high-frequency field generated by high-frequency inductor, and a material supply line for blowing in initial material with a transport gas into the plasma generated by high-frequency inductor with the plasma gas.

22. The carbon material according to claim 20, further characterized in that the modified edges have a rounded shape in comparison to unmodified edges.

23. The carbon material according to claim 20, further characterized in that it has an irreversible absorbing capacity for alkali and/or alkaline-earth ions that is reduced in comparison to untreated initial carbon material.

24. The carbon material according to claim 20, further characterized in that this material has graphitic and/or non-graphitic carbon components and also, optionally, hydrocarbon components.

25. Use of a carbon material according to claim 20 or which can be produced by a method comprising the steps of generation of a high-frequency field in a chamber of a plasmatron; introduction of a plasma gas into chamber; generation of a plasma with the plasma gas by the high-frequency field; and introduction of initial material into the plasma or with a plasmatron having: a chamber, at least one high-frequency inductor disposed in at least one region of chamber, a gas supply line for introducing a plasma gas into the region of a high-frequency field generated by high-frequency inductor, and a material supply line for blowing in initial material with a transport gas into the plasma generated by high-frequency inductor with the plasma gas as an electrode material for a lithium-ion rechargeable battery.

26. The use according to claim 25, further characterized in that the electrode material is an anode material.

27. The use according to claim 25, further characterized in that the carbon material is shaped into an anode.

28. Use of a carbon material according to claim 20 or which can be produced by a method comprising the steps of generation of a high-frequency field in a chamber of a plasmatron; introduction of a plasma gas into chamber; generation of a plasma with the plasma gas by the high-frequency field; and introduction of initial material into the plasma or with a plasmatron having: a chamber, at least one high-frequency inductor disposed in at least one region of chamber, a gas supply line for introducing a plasma gas into the region of a high-frequency field generated by high-frequency inductor, and a material supply line for blowing in initial material with a transport gas into the plasma generated by high-frequency inductor with the plasma gas as an additive.

29. The use according to claim 28, further characterized in that the carbon material is mixed with an initial material in order to form a composite material.
